(19) United States
(12) Patent Application Publication
(10) Pub. No.: US 2009/0186129 A1
(43) Pub. Date: Jul. 23, 2009

(54) LOW-COST, SHELF-STABLE CHEESE SAUCE

(75) Inventors: Aly Y. Gamay, McLean, VA (US); Cary Gammons, Waldorf, MD (US); Erika B. Smith, Champlin, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: General Mills, Minneapolis, MN (US)

(21) Appl. No.: 12/016,084

(22) Filed: Jan. 17, 2008

(51) Int. Cl. A23C 19/00; B65D 85/76

(52) U.S. Cl. 426/87; 426/582

(57) ABSTRACT

A cheese sauce and meal kit including at least one pouch containing the cheese sauce. The cheese sauce exhibits desirable texture and mouth-feel, as well as desirable flavor and visual appearance. Further, the cheese sauce has a shelf-life of up to twelve months or more. The cheese sauce generally includes cheese solids present in an amount from about 10 weight percent or less, at least one non-cheese dairy, water, a natural preservative such as nisin, at least one phosphate, salt, oil, and a savory flavor profile. The cheese sauce can be processed using a pasteurization process, and packaged using a hot fill process. The cheese sauce can be packaged into pouches and the like for use with meal kits and side dishes.

### FIELD OF THE INVENTION

The current invention relates generally to cheese sauce. More particularly, the current invention relates to a low-cost, low cheese solid content, pasteurized/processed hot fill cheese sauce.

### BACKGROUND OF THE INVENTION

Imitation cheese sauces, such as those packaged in pouches, are often used in the food industry as components in food kits, such as, for example, meal kits, side dishes, and snack kits. Generally, food kits can include at least one pre-packaged food component or ingredient, and the cheese sauce component. The pre-packaged food components can include, for example, dried pasta, refrigerated pasta, refrigerated meats, snack chips, rice, taco bake, potatoes, dehydrated vegetables, refrigerated vegetables, dough products, pizza-making components, and combinations thereof. The food component is prepared either as a separate step or simultaneously with the cheese sauce component. Side dishes such as, for example, potato kits, can incorporate cheese sauces to be added into a potato casserole as an ingredient and/or added to the exterior of the casserole for pleasing visual attributes or additional flavor. Cheese sauces can be used in meal kits such as, for example, taco bakes, as a component to be combined with the meat component and/or spread over the top of the bake prior to baking.

Desirable cheese sauce products exhibit certain qualitative and quantitative performance attributes. These cheese sauce products should have favorable flavor, mouth-feel, viscosity, and color, and should closely resemble a cheese variety. Further, for baked products, the cheese sauce product should exhibit adequate surface melt or cling to the baked product. The cheese sauce product should also exhibit adequate stability in the pouch including good squeezability and emulsion stability with limited syneresis. Finally, the cheese sauce product should exhibit shelf life stability, such as, for example, a shelf life of up to twelve months without spoilage.

Cheese sauce products are currently processed one of three ways: (1) pasteurization and hot fill; (2) ultra heat treatment (“UHT”) process and aseptic filling/packaging; or (3) retort processing. Pasteurization processes are used for heating liquids, such as milk and other dairy products, for the purpose of destroying viruses and harmful organisms such as bacteria, protozoa, molds, and yeasts, but is not used as a sterilization process to kill pathogens. Pasteurization is typically carried out at temperatures below boiling so as not to irreversibly aggregate, or curdle, dairy products. The pasteurization and hot fill process is most commonly used in cheese sauce processing and includes heating the cheese sauce to at least 150 degrees Fahrenheit without reaching boiling, and holding for about 30 seconds. This process is typically used on cheese sauces with a cheese solids content of about 20 percent by weight or greater.

The UHT and aseptic filling and packaging process can be used on cheese sauces with lower cheese solid. The UHT confers commercial sterility by heating the cheese sauce to at least 250 degrees Fahrenheit, and holding for about 2 to about 5 seconds hold time. Although the UHT process has been highly successful in perishable-prone products, high capital and maintenance costs are often associated with the UHT process.

Retort processing includes a time and temperature dependent process that is determined by the rate of heat transfer through the package. However, for cheese sauce containing high levels of cheese solids, a low quality cheese sauce product results when using retort processing because the cheese sauce is not stable at such severe retort conditions.

In the 1980s, extensive studies were conducted to develop safety standards for the processing of shelf-stable cheese products with cheese solids greater than about 20% by weight, such as, for example, cheese sauces and spreads. See Tanaka, et al., J. of Food Protection, Vol. 49, No. 7, pp. 526-531 (1986). Tanaka et al. experimented with parameters such as sodium phosphate (Na₂PO₄) and sodium chloride (NaCl) levels, as well as pH and moisture content to establish safety standards for pasteurization and hot fill processes. Challenge studies included pre- and post-inoculation of C. botulinum. Tanaka et al. developed the following FDA-approved safety standards for cheese sauces and spreads containing over 20% cheese solids: pH<5.7, moisture content<54% and NaCl/Na₂PO₄ in the 3.5%-7% range. Cheese sauces and spreads within or outside of these standards require micro challenge studies followed by FDA filing.

Cheese sauces today generally contain from about 20 to about 50% by weight of cheese solids to accomplish the product attributes described above. Cheese products with 51% or greater of cheese solids are characterized as “spreads” rather than “sauces.” With these relatively high levels of cheese solids in current sauce, the cost of cheese is critical in the cost of manufacturing the cheese sauce. As the price of cheese rises, the cost of the cheese sauce also rises. An effective method of lowering manufacturing costs of producing cheese sauces is to lower the level of cheese solids. However, current technologies, as discussed above prevent decreasing cheese content to below about 24% by weight.

There remains a need for a cheese sauce that is low cost, is shelf stable, and can be safely processed using standard processes such as pasteurization and hot fill.

### SUMMARY OF THE INVENTION

The present invention provides a low-cost, shelf-stable cheese sauce that exhibits desirable texture, mouth-feel, flavor, visual appearance, and shelf-life stability. The cheese sauce of the present invention successfully passes challenge studies, such as pathogenic studies, as required by the FDA, and has a shelf-life for up to twelve months or more.

The cheese sauce of the present invention generally includes cheese solids present in an amount from about 10 weight percent or less, at least one non-cheese dairy ingredient, water, a natural preservative such as nisin present in an amount from about 500 parts per million or less, at least one salt, such as for, example, phosphate salt or sodium chloride, oil, and a savory flavor profile. In one embodiment of the invention, the cheese solids are present in the amount of 5 weight percent or less of the total cheese sauce formulation.

The cheese sauce of the current invention is processed using a pasteurization process, and packaged using a hot fill process. Preferably, the cheese sauce is packaged into pouches or the like. In one embodiment of the invention, a food kit generally includes at least one pre-packaged food component, at least one pouch containing a cheese sauce, and instructions on how to combine the meal component and cheese sauce. Such pre-packaged food components can include, for example, dried pasta, refrigerated pasta, refrigerated meats, snack chips, rice, taco bake, potatoes, dehydrated vegetables, refrigerated vegetables, dough products, pizza-making components, and combinations thereof, as described above.

The above summary of the invention is not intended to describe each illustrated embodiment or every implementation of the present invention. The detailed description that follows more particularly exemplifies these embodiments.

### DETAILED DESCRIPTION

The cheese sauce of the current invention provides a lower-cost cheese sauce than standard cheese sauces of cheese solid levels of 20 percent weight or greater. The cheese sauce of the current invention incorporates lower cheese solid levels which aid in reducing the cost, while utilizing standard production techniques such as pasteurization and hot-fill processing without diminishing the quality of the cheese sauce. To accomplish this, other less costly components are added to overcome the sensory, economic, and pathogenic issues associated with lowering cheese solids. Such issues can include, for example, flavor, rheological or functional properties such as texture or mouth-feel and flow properties, visual properties, shelf-stability, and any of a number of properties desired in a cheese sauce, as discussed above. The cheese sauce of the present invention must also be commercially viable in that it must pass challenge studies, such as pathogenic studies, as required by the FDA, and should be shelf-stable for up to twelve months. The cheese sauce can be stored at room temperature or refrigerated. Further, it is desirable to formulate a cheese sauce that meets the Tanaka safety standards regarding pH value, viscosity, and salt, phosphate salts, and moisture levels.

The cheese sauce of the current invention generally includes cheese solids present at a concentration of 10 weight percent or less of the total cheese sauce formulations, other dairy solids, a natural preservative such as nisin, oil, emulsifiers, salts such as phosphate salts and sodium chloride, water and a flavor profile. The cheese sauce can further include components such as fillers, texture additives, lactic acid, sorbic acid, colors, and other such components.

Cheese sauces of the present invention can be formulated to imitate any of a number of cheese flavorings such as cheddar cheese, white cheddar cheese, Italian cheese blends, nacho cheese, and the like. The cheese solids used in the cheese sauce compositions of the present invention depends on the final use of the cheese sauce. Real block cheese, such as cheddar cheese, can be used, for example, when producing a cheddar cheese sauce or the like.

The age of the cheese used as the cheese solids affects the flavor of the resulting cheese sauce. For example, a younger cheese or a cheese that has been aged from about two to about five months will be milder and blander, whereas an older cheese that has been aged for five or more years will add a sharper, more flavorful finish to the cheese sauce. However, older cheeses tend to be more expensive than younger cheeses. Therefore, it can be advantageous to blend older and younger cheeses to get a specific cheese age for the desired flavor contribution.

As described above, a cheese sauce product does not have a standard identity, meaning that a food product does not require specific cheese solids content in the industry to be identified as a cheese sauce. In one embodiment of the invention, cheese solids are present in the amount of about 10 percent or less by weight of the total formulation of the cheese sauce. More particularly, cheese solids are present in the amount of about 5 percent or less by weight of the total formulation of the cheese sauce.

To compensate for the lower levels of cheese solids than current cheese sauce formulations, dairy solids other than cheeses that are lower in cost than cheese can be added to the cheese sauce formulation. Dairy solids, such as, for example, butter milk, whey, and any of a variety of dairy solids or combinations thereof can be used. In one embodiment of the invention, dairy solids can comprise non-fat milk solids, such as, for example, non-fat dry milk, rennet casein, milk protein concentrate, and any variety of non-fat milk solids and combinations thereof. The addition of non-fat dairy solids in place other dairy solids provide a healthier cheese sauce because of the lower levels of fat content, and particularly saturated fat content.

The dairy solids compensate not only for viscosity and body, but also for the total moisture, protein, and salt content that is lost when lower cheese solids are used. The moisture, protein, and salt levels are important to control the desired attributes of a cheese sauce, such as, for example, flavor and texture, as described above. Sweet whey can be used, for example, which contributes to flavor, as well as the solids level. In one embodiment of the invention, dairy solids other than cheese are present in an amount ranging from about 1 weight percent to about 25 weight percent of the total formulation of the cheese sauce, preferably from about 5 weight percent to about 15 weight percent, and more preferably about 10 weight percent. Dairy solids can also contribute to the total fat content. In one embodiment of the invention, the total fat content ranges from about 15 weight percent to about 30 weight percent, and preferably from about 19 weight percent to about 25 weight percent.

The viscosity and the total moisture content of the cheese formulation depend on the amount of water present in the cheese formulation. Water can also be present in the form of condensate, such as, for example, from steam used in the pasteurization process. In one embodiment of the invention, water is present in a total amount from about 20 weight percent to about 60 weight percent of the cheese sauce formulation. In one particular embodiment, the total moisture content ranges from about 45 to about 54 weight percent.

The cheese sauce formulation typically comprises oils to create an emulsion with the water. Suitable oils can include, for example, soybean oil, canola oil, vegetable oil, olive oil, palm oil, peanut oil, and any other suitable oil or combinations thereof. It can be advantageous to use a trans-free oil system, such as soybean oil, canola oil, and blends thereof, for lower levels of saturated fat than standard cheese sauces at higher cheese solids content. In one embodiment of the invention, soybean oil is present in an amount in the range from about 0.1 to about 5 weight percent of the total formulation of the cheese sauce, and canola oil is present in an amount in the range from about 10 to about 20 weight percent of the total formulation of the cheese sauce. Other suitable trans-free oils can be used as an alternative to or in addition to soybean oil and/or canola oil.

The addition of oil however, tends to negatively impact textures in the cheese sauce. To manipulate and regain the desired textures, texture additives and fillers can be used in the cheese sauce formulation of the present invention. Suitable fillers can include corn syrup solids, maltodextrins, and any of a number of suitable fillers and combinations thereof. However, the use of maltodextrins should be closely monitored because higher levels of maltodextrins can induce bad sensory characteristics such as taste, or an undesired “fluffiness” characteristic. In one embodiment of the invention, fillers are present in a range from about 0.1 weight percent to about 15 weight percent of the total formulation of the cheese sauce. In a particular embodiment, a filler having a 1:1 blend of corn syrup solids and maltodextrin are present in a total concentration from about five to about ten percent of the total formulation of the cheese sauce.

Other texture additives or fillers include gums which help to control viscosity of the cheese sauce. A suitable gum can be mixed into the formulation, which interacts with and stabilizes proteins in the sauce formulation. Further, a suitable gum should have minimal affect on the pH of the cheese sauce formulation. Suitable gums can include, for example, sodium alginate, guar gum, xanthan gum, and any of a variety of suitable gums or combinations thereof. In one embodiment of the invention, a gum system is present in a range of about 0.1 weight percent to about 5 weight percent of the total formulation of the cheese sauce. In a particular embodiment, the gum system includes a combination of sodium alginate and xantham gums.

The cheese sauce is essentially an emulsion of water and oil, as described above. Emulsifiers, such as, for example, mono- and di-glycerides, can be added to the cheese sauce to provide emulsion stability. Emulsion stability impacts shelf-life. Shelf-life includes providing a stable emulsion for a length of time such as up to twelve months or more. In one embodiment of the invention, at least one emulsifier is present in a range from about 0.1 to about 5 weight percent of the total formulation of the cheese sauce.

The pH value of the cheese sauce is important to balance bacterial and pathogen growth with desirable texture and/or taste. For example, if the cheese formulation is too acidic, the cheese sauce may have a sour, undesirable taste, or even exhibit curdling. On the other hand, if the cheese formulation is too basic, the cheese sauce may have a bitter, undesirable taste, or can promote bacteria and pathogen growth. The pH can be manipulated any of a variety of ways, such as, for example, by the addition of salts such as phosphate salts and/or sodium chloride, sorbic acid, and the like. In one embodiment of the invention, the pH value of the cheese sauce formulation ranges from about 5.45 to about 5.65.

As mentioned above, phosphate salts are added to aid in balancing the pH of the cheese sauce formulation, which in turn, has effect on the flavor and texture of the cheese sauce product. Furthermore, phosphate salts solubilize proteins in the form of cheese and dairy solids, which in turn act as emulsifiers. A blend of mono- and di-phosphate salts, such as, for example, sodium phosphate, can be used to carefully balance the pH to ensure a high quality cheese sauce including desirable taste and texture, while inhibiting pathogen and bacterial growth. For example, a cheese sauce with a high level of mono-sodium phosphate salt can be too acidic, and a cheese sauce with a high level of di-sodium phosphate salt can be too basic. In one embodiment of the invention, a phosphate system including mono- and di-sodium phosphate is present at a concentration from about 1 weight percent to about 5 weight percent of the total cheese sauce formulation. In another embodiment of the invention, the ratio of di-sodium phosphate to mono-sodium phosphate is at least two to one.

Other salts, such as mineral salts, can be present in the cheese sauce formulation from a variety of sources including the cheese and dairy solids. Additional salt, such as sodium chloride, can be added for flavor, and to aid in regulating the pH of the total formulation in combination with the phosphate salts. In one embodiment of the invention, sodium chloride is present in a total amount of about 0.1 weight percent to about 3 weight percent of the total cheese sauce formulation, and preferably from about 1.8 to about 2.2 weight percent.

The cheese sauce formulation can also include a savory flavor system. The flavor system should be chosen to most closely imitate a particular flavor profile. Further, the flavor system should have minimal impact on the texture and the pathogen growth of the cheese sauce. Commonly used flavors and spices can include, for example, garlic powder, onion powder, tomato powder, cumin powder, chili powder, monosodium glutamate (MSG), purees such as jalapeno, onion, parsley, or garlic purees, green, red, and jalapeno peppers, black pepper, sugar, and any of a variety of suitable flavors and combinations thereof. In one embodiment of the invention, a flavor system is present in an amount ranging from about 0.1 weight percent to about 10 weight percent of the total cheese sauce formulation.

Additional components can be added to perform specific functions, such as, stabilize the emulsion, provide shelf stability, and regulate the pH. Sorbic acid can be added, for example, as a yeast or mold inhibitor to extend the shelf-life stability. In one embodiment of the invention, sorbic acid is present in an amount ranging from 0.01 weight percent to 1 weight percent of the total cheese sauce formulation. Lactic acid can be added, for another example, to further adjust the pH to avoid the consequences associated with using excessive amounts of phosphate salts. Further, colorings, such as, for example, titanium dioxide, can be added to gain the desired visual aesthetic while minimally affecting texture and pH of the cheese sauce.

Finally, natural preservatives can be added to inhibit the growth of microbial growth over time, thereby increasing the shelf-life of the food product. In one embodiment of the invention, nisin, a polycyclic peptide antibacterial, is added in an amount up to about 500 ppm of the total cheese sauce formulation, which is the maximum approved by the FDA for sauces. It is preferred to use the maximum level because nisin degrades over time. Therefore, it is preferable to have from about 200 to about 250 ppm of nisin remaining at the end of the shelf life of the cheese sauce. In an alternative embodiment, cultured dextrose is used in place of nisin in countries that have not approved the use of nisin.

### Representative Method of Preparation

A cheese sauce according to the present invention can be made by the following method: The cheese solids, flavor system, and glycerides are combined and added into a cooking vessel, such as a steam cooker. One or more sources of fat, such as animal fats including butter, butter milk, and lard, and/or vegetable fats such as vegetable, palm, soy, and canola oils, are then added to the contents of the cooker in combination with heat, such as, in the form of steam. The contents of the cooker are then heated to at least 170 degrees Fahrenheit without boiling. The heat source is then reduced while a portion of the water, the oil system, and any lactic acid used in the formulation is added to the cooker.

A separate slurry is prepared which can comprise any whey, texture additives, fillers, and the remaining portion of water. The slurry is pumped into the cooker in combination with heat until the contents of the cooker reach at least 160 degrees Fahrenheit without boiling. This entire process extends for about five to about ten minutes to pasteurize the cheese sauce without ever boiling it.

The cheese sauce is then transferred from the cooker to surge tanks and the contents are kept at a temperature of at least about 160 degrees Fahrenheit. The cheese sauce can then be optionally pumped through a homogenizer to emulsify the fat content. The cheese sauce is then hot-filled into the desired packaging, such as, for example, flexible pouches, plastic, ceramic, or glass containers, or any of a variety of desired packaging types. In one embodiment of the invention, the cheese sauce is hot-filled into a plurality of pouches, such as, for example, flexible polyethylene pouches lined with an aluminum foil laminate.

The above representative method was used to create three different cheese sauces: (1) a control sauce with no preservative; (2) a cheese sauce with nisin as a preservative; and (3) a cheese sauce with cultured dextrose as a cheese sauce. Challenge studies and economic spoilage studies were conducted on each of the three formulations. Variations within the scope of the disclosure will be apparent to those skilled in the art.

Formulation 1: Low-cost cheese sauce without a natural preservative (Control)

| Component | Wt % of total formulation |
|---|---|
| Cheese solids | 5 |
| Oil system | 18 |
| Glycerides | 0.3 |
| Phosphate salt(s) | 3.5 |
| Sodium chloride (added as | 1 |
| separate component) | |
| Other dairy solids | 10 |
| Fillers and gums | 8.8 |
| Natural and Artificial | 6.41 |
| flavors and spices | |
| Sorbic acid | 0.1 |
| Color | 0.27 |
| Nisin | 0 |
| Cultured dextrose | 0 |
| Lactic acid | 0.33 |
| Condensate | 10 |
| Water | 36.29 |
| Total | 100 |

Formulation 2: Low-Cost Cheese Sauce with Nisin

| Component | Wt % of total formulation |
|---|---|
| Cheese solids | 5 |
| Oil system | 18 |
| Glycerides | 0.3 |
| Phosphate salt(s) | 3.5 |
| Sodium chloride (added as | 1 |
| separate component) | |
| Other dairy solids | 10 |
| Fillers and gums | 8.8 |
| Natural and Artificial | 6.41 |
| flavors and spices | |
| Sorbic acid | 0.1 |
| Color | 0.27 |
| Nisin | 0.05 |
| Cultured dextrose | 0 |
| Lactic acid | 0.33 |
| Condensate | 10 |
| Water | 36.24 |
| Total | 100 |

Formulation 3: Low-Cost Cheese Sauce with Cultured Dextrose

| Component | Wt % of total formulation |
|---|---|
| Cheese solids | 5 |
| Oil system | 18 |
| Glycerides | 0.3 |
| Phosphate salt(s) | 3.5 |
| Sodium chloride (added as | 1 |
| separate component) | |
| Other dairy solids | 10 |
| Fillers and gums | 8.8 |
| Natural and Artificial | 6.41 |
| flavors and spices | |
| Sorbic acid | 0.1 |
| Color | 0.27 |
| Nisin | 0 |
| Cultured dextrose | 0.5 |
| Lactic acid | 0.33 |
| Condensate | 10 |
| Water | 35.79 |
| Total | 100 |

### Microbiological Challenge Studies

Challenge studies are used to measure the microbial growth and economic spoilage in a cheese sauce product over a period of time, such as, for example, from 3 to 24 months. The challenge studies are typically used for cheese products that are produced outside of the Tanaka standards, as described above. The studies can include, for example, an inoculated and a non-inoculated, or control, sample of each of the cheese sauces.

A pathogenic challenge study is required by the FDA for cheese sauces to determine whether the Tanaka standards are met and the product is safe for consumption. In one embodiment of the invention, a pathogenic challenge study was carried out for 24 months using inoculated and control samples of the Formulas I-3 listed above. The inoculated samples were inoculated with spores of a 10 strain mixture of C. botulinum followed by incubation at 86 degrees Fahrenheit. A summary of the initial data from Day 0 of the study can be found in Table 1:

TABLE 1
Summary for moistures^{a}, pH^{b}, salt^{c}, water activity^{d}, aerobic^{e} and anaerobic^{f} plate count,
Clostridium botulinum MPN (spores/g)^{g}, and botulinal toxin detection^{h}, for Day 0.

| | Target | | | % | | Aerobic | Anaerobic | | |
|---|---|---|---|---|---|---|---|---|---|
| | moisture, pH | Actual % | Actual | NaCl | Water | plate count | plate count | MPN | Botulinal |
| Formulation | and NaCl | moisture | pH | (Total) | Activity | (CFU/g) | (CFU/g) | (spores/g) | toxicityⁱ |
| I: Cheese | 52.5-53.5 | 53.73 | 5.73 | 1.82 | 0.948 | 65 | 320 | 480 | 0 |
| sauce w/o | 5.70-5.80 | 52.48 | 5.75 | 1.85 | 0.946 | 45 | 445 | 600 | 0 |
| Nisin^{j} | 1.8-2.2 | 52.82 | 5.75 | 1.89 | 0.945 | 15 | 385 | 1800 | 0 |
| Average | | 53.01 | 5.74 | 1.85 | 0.946 | 42 | 383 | 960 | |
| II: Cheese | 52.5-53.5 | 52.59 | 5.74 | 1.88 | 0.942 | 35 | 280 | 480 | 0 |
| sauce w/ | 5.70-5.80 | 52.97 | 5.76 | 1.91 | 0.943 | 30 | 215 | 600 | 0 |
| Nisin^{k} | 1.8-2.2 | 52.18 | 5.74 | 1.90 | 0.942 | 35 | 250 | 1800 | 0 |
| Average | | 52.59 | 5.75 | 1.90 | 0.942 | 33 | 248 | 960 | |
| III. Cheese | 52.5-53.5 | 51.71 | 5.74 | 1.89 | 0.945 | 10 | 310 | 1000 | 0 |
| sauce w/ | 5.70-5.80 | 52.86 | 5.74 | 1.89 | 0.945 | 5 | 275 | 600 | 0 |
| cultured | 1.8-2.2 | 52.51 | 5.73 | 1.91 | 0.944 | 20 | 265 | 1000 | 0 |
| dextrose^{l} | | | | | | | | | |
| Average | | 52.36 | 5.74 | 1.90 | 0.945 | 12 | 283 | 867 | |

^{a}Vacuum oven method, 5 h, 212° F. (100° C.) (AOAC 934.01)
^{b}pH determined with Orion 8104 combination pH electrode and Accumet pH meter
^{c}NaCl analyzed as Cl⁻, Brinkman automated titrator, silver nitrate titration
^{d}measured using Aqua Lab CX-2 water activity meter, average temperature of 76.8, 77.4, 78.1° F. (24.9, 25.2, 25.6° C.), respectively
^{e}Plate Count agar, 0.1 ml pour plate, 86-98.6° F. (30-37° C.), 48 h.
^{f}Reinforced clostridial agar, 0.1 ml pour plate, 86-98.6° F. (30-37° C.), anaerobically, 48 h.
^{g}5 tube MPN (most probable number), FDA Bacteriological Analytical Manual, 8^{th} edition, 1995
^{h}Mouse toxicity test, FDA Bacteriological Analytical Manual, 8^{th} edition, 1995
ⁱ0 = no toxicity detected, + = botulinal toxin confirmed
^{j}Average moisture, pH, % NaCl, and A_{w} (temp) for base = 52.68, 5.66, 1.84, 0.947 at 78.6° F. (25.9° C.)
^{k}Average moisture, pH, % NaCl, and A_{w} (temp) for base = 52.89, 5.69, 1.90, 0.944 at 78.4° F. (25.8° C.)
^{l}Average moisture, pH, % NaCl, and A_{w} (temp) for base = 52.35, 5.56, 1.91, 0.945 at 71.8° F. (22.1° C.)

A period of time of two times the shelf life was carried out with intermittent assays. A failing grade in the pathogenic challenge studies is defined as when there is a lethal amount of pathogenic bacteria found in the cheese sauce at any time during the test period. The three cheese sauce formulations, regardless of whether nisin is present, did not exhibit a lethal amount of pathogenic bacteria after 24 months. The results of the study are captured in Tables 2-7 below:

TABLE 2
Summary of moistures^{a}, aerobic^{b}, and anaerobic plate count^{c}, and Clostridium
botulinum MPN (spores/g)^{d} after 12 months storage at 86° F. (30° C.).

| | | Aerobic | Anaerobic | |
|---|---|---|---|---|
| | | plate count | plate count | MPN |
| Formulation | % Moisture | (CFU/g) | (CFU/g) | (spores/g) |
| I: Cheese sauce w/o Nisin | 49.8 | 10 | 120 | 100 |
| | 52.3 | 130 | 100 | 60 |
| II: Cheese sauce w/ Nisin | 52.2 | 10 | 20 | 60 |
| | 52.8 | 10 | 170 | 60 |
| III: Cheese sauce w/ cultured | 53.2 | 20 | 100 | 560 |
| dextrose | 52.6 | 40 | 160 | 46 |

^{a}Vacuum oven method, 5 h, 212° F. (100° C.) (AOAC 934.01)
^{b}Plate Count agar, 0.1 ml pour plate, 98.6° F. (37° C.), 48 h.
^{c}Reinforced Clostridial agar with, 0.1 ml pour plate, 98.6° F. (37° C.), anaerobically, 48 h.
^{d}5 tube MPN (most probable number), FDA Bacteriological Analytical Manual, 8^{th} edition, 1995

TABLE 3
Summary of moistures^{a}, aerobic^{b}, and anaerobic plate count^{c}, and Clostridium
botulinum MPN (spores/g)^{d} after 24 months storage at 86° F. (30° C).

| | | Aerobic | Anaerobic | |
|---|---|---|---|---|
| | | plate count | plate count | MPN |
| Formulation | % Moisture | (CFU/g) | (CFU/g) | (spores/g) |
| I: Cheese sauce w/o Nisin | 51.3 | 10 | <10 | 100 |
| | ND | 10 | <10 | 48 |
| | 49.3 | <10 | <10 | 26 |
| II: Cheese sauce w/ Nisin | 51.3 | <10 | <10 | 60 |
| | 50.7 | <10 | <10 | 100 |
| | 50.8 | <10 | <10 | 44 |
| III: Cheese sauce w/ cultured | N/A | <1.00 | <1.00 | 60 |
| dextrose | N/A | <1.00 | <1.00 | 26 |
| | N/A | <1.00 | <1.00 | 180 |

^{a}Vacuum oven method, 5 h, 212° F. (100° C.) (AOAC 934.01)
^{b}Plate Count agar, 0.1 ml pour plate, 98.6° F. (37° C.), 48 h.
^{c}Differential Reinforced Clostridial agar with, 0.1 ml pour plate, 98.6° F. (37° C.), anaerobically, 48 h.
^{d}5 tube MPN (most probable number), FDA Bacteriological Analytical Manual, 8^{th} edition, 1995

TABLE 4
Summary for moistures^{a}, pH^{b}, salt^{c}, and water activity^{d} for process
cheese formulations after 24 months incubation at 86° F. (30° C.).

| | % | | % NaCl | Water |
|---|---|---|---|---|
| Formulation | moisture | pH | (Total) | Activity |
| I: Cheese sauce w/o Nisin | 51.33 | see 24 month | 1.82 | 0.942 |
| | 39.93 | data | 1.74 | 0.918 |
| | 49.29 | in T.5 | 1.89 | 0.939 |
| Average | 46.85 | 5.43 | 1.82 | 0.933 |
| II: Cheese sauce w/ Nisin | 51.31 | see 24 month | 1.93 | 0.942 |
| | 50.70 | data | 1.91 | 0.941 |
| | 50.83 | in T.6 | 1.92 | 0.939 |
| Average | 50.95 | 5.45 | 1.92 | 0.941 |
| III: Cheese sauce w/ | 51.90 | see 24 month | 1.86 | 0.940 |
| cultured dextrose | 51.30 | data | 1.88 | 0.941 |
| | 49.26 | in T.7 | 1.96 | 0.935 |
| Average | 50.82 | 5.44 | 1.90 | 0.939 |

^{a}Vacuum oven method, 5 h, 212° F. (100° C.) (AOAC 934.01)
^{b}pH determined with Orion 8104 combination pH electrode and Accumet pH meter
^{c}NaCl analyzed as Cl⁻, Mettler Toledo DL22 Food and Beverage analyzer, silver nitrate titration
^{d}measured using Aqua Lab CX-2 water activity meter, average temperature = 78.3° F. (25.7° C.) for all

TABLE 5
Summary of pH^{a}, botulinal toxicity^{b}, and sensory evaluation^{c}, on Formulation I: Cheese
sauce without Nisin inoculated with Clostridium botulinum and stored at 86° F. (30° C.).

| Timepoint | Sample | pH | Botulinal toxicity^{d} | Sensory |
|---|---|---|---|---|
| 2 month | 1 | 5.78 | 0 | Normal odor and appearance; edible |
| | 2 | 5.69 | 0 | ″ |
| | 3 | 5.69 | 0 | ″ |
| | 4 | 5.68 | 0 | ″ |
| | 5 | 5.68 | 0 | ″ |
| 4 month | 1 | 5.69 | 0 | Normal odor, small pockets of watery separation throughout |
| | 2 | 5.70 | 0 | ″ |
| | 3 | 5.67 | 0 | ″ |
| | 4 | 5.68 | 0 | ″ |
| | 5 | 5.71 | 0 | ″ |
| 6 month | 1 | 5.72 | 0 | Normal odor, slight watery separation, slight gas production; edible |
| | 2 | 5.76 | 0 | ″ |
| | 3 | 5.72 | 0 | ″ |
| | 4 | 5.71 | 0 | ″ |
| | 5 | 5.71 | 0 | ″ |
| 9 month | 1 | 5.68 | 0 | Normal odor, pockets of oily separation throughout; edible |
| | 2 | 5.66 | 0 | ″ |
| | 3 | 5.63 | 0 | ″ |
| | 4 | 5.64 | 0 | Normal odor, oily separation on bottom; edible |
| | 5 | 5.60 | 0 | Normal odor, pockets of oily separation |
| | | | | throughout; edible |
| 12 month | 1 | NT^{e} | 0 | Oily separation throughout, darkening; edible |
| | 2 | 5.61 | 0 | ″ |
| | 3 | 5.57 | 0 | ″ |
| | 4 | 5.63 | 0 | Normal odor, darkening; edible |
| | 5 | 5.69 | 0 | ″ |
| 18 month | 1 | 5.50 | 0 | Oily separation throughout, darkening, normal odor, edible |
| | 2 | 5.49 | 0 | ″ |
| | 3 | 5.49 | 0 | ″ |
| | 4 | 5.50 | 0 | ″ |
| | 5 | 5.58 | 0 | ″ |
| 24 month | 1 | 5.46 | 0 | Oily separation throughout, darkening, normal odor; edible |
| | 2 | 5.45 | 0 | ″ |
| | 3 | 5.44 | 0 | ″ |
| | 4 | 5.32 | 0 | ″ |
| | 5 | 5.47 | 0 | ″ |

^{a}pH determined with Orion 8104 combination pH electrode and Accumet pH meter
^{b}Mouse toxicity test, FDA Bacteriological Analytical Manual, 1995
^{c}Considered edible based on odor and appearance
^{d}0 = no toxicity detected, + = botulinal toxin confirmed
^{e}NT = not tested, insufficient sample remaining for pH (vial leaked in storage)

TABLE 6
Summary of pH^{a}, botulinal toxicity^{b}, and sensory evaluation^{c}, on Formulation II:
Cheese sauce with Nisin inoculated with Clostridium botulinum and stored at 86° F. (30° C.).

| Timepoint | Sample | pH | Botulinal toxicity^{d} | Sensory |
|---|---|---|---|---|
| 2 month | 1 | 5.77 | 0 | Normal odor and appearance; edible |
| | 2 | 5.70 | 0 | ″ |
| | 3 | 5.71 | 0 | ″ |
| | 4 | 5.69 | 0 | Small pockets of oily separation; edible |
| | 5 | 5.69 | 0 | ″ |
| 4 month | 1 | 5.70 | 0 | Normal odor, small pockets of separation throughout |
| | 2 | 5.73 | 0 | ″ |
| | 3 | 5.74 | 0 | ″ |
| | 4 | 5.72 | 0 | Normal odor and appearance; edible |
| | 5 | 5.72 | 0 | ″ |
| 6 month | 1 | 5.68 | 0 | Normal odor, slight watery separation; edible |
| | 2 | 5.70 | 0 | ″ |
| | 3 | 5.67 | 0 | ″ |
| | 4 | 5.67 | 0 | ″ |
| | 5 | 5.74 | 0 | ″ |
| 9 month | 1 | 5.69 | 0 | Normal odor, oily separation in pockets throughout; edible |
| | 2 | 5.60 | 0 | ″ |
| | 3 | 5.60 | 0 | ″ |
| | 4 | 5.58 | 0 | Normal odor and appearance; edible |
| | 5 | 5.59 | 0 | ″ |
| 12 month | 1 | 5.57 | 0 | Oily separation throughout, darkening; edible |
| | 2 | 5.66 | 0 | Normal odor, darkening; edible |
| | 3 | 5.64 | 0 | ″ |
| | 4 | 5.61 | 0 | Oily separation throughout, darkening; edible |
| | 5 | 5.63 | 0 | ″ |
| 18 month | 1 | 5.54 | 0 | Oily separation throughout, darkening, normal odor, edible |
| | 2 | 5.53 | 0 | ″ |
| | 3 | 5.53 | 0 | ″ |
| | 4 | 5.51 | 0 | ″ |
| | 5 | 5.61 | 0 | ″ |
| 24 month | 1 | 5.46 | 0 | Darkening, normal odor; edible |
| | 2 | 5.47 | 0 | ″ |
| | 3 | 5.43 | 0 | ″ |
| | 4 | 5.45 | 0 | Oily separation throughout, darkening, normal odor, edible |
| | 5 | 5.45 | 0 | ″ |

^{a}pH determined with Orion 8104 combination pH electrode and Accumet pH meter
^{b}Mouse toxicity test, FDA Bacteriological Analytical Manual, 1995
^{c}Considered edible based on odor and appearance
^{d}0 = no toxicity detected, + = botulinal toxin confirmed

TABLE 7
Summary of pH^{a}, botulinal toxicity^{b}, and sensory evaluation^{c}, on Formulation III:
Cheese sauce with cultured dextrose inoculated with Clostridium botulinum and stored at 86° F.
(30° C.).

| Timepoint | Sample | pH | Botulinal toxicity^{d} | Sensory |
|---|---|---|---|---|
| 2 month | 1 | 5.77 | 0 | Normal appearance; edible |
| | 2 | 5.69 | 0 | ″ |
| | 3 | 5.67 | 0 | ″ |
| | 4 | 5.69 | 0 | ″ |
| | 5 | 5.67 | 0 | ″ |
| 4 month | 1 | 5.75 | 0 | Normal odor, a few small pockets of separation |
| | 2 | 5.74 | 0 | ″ |
| | 3 | 5.74 | 0 | Normal odor and appearance; edible |
| | 4 | 5.74 | 0 | ″ |
| | 5 | 5.85 | 0 | Possible gas production, very slightly putrid smell; edible |
| 6 month | 1 | 5.76 | 0 | Normal odor, slight watery separation, slight gas production; edible |
| | 2 | 5.65 | 0 | Normal odor, slight watery separation; edible |
| | 3 | 5.66 | 0 | ″ |
| | 4 | 5.65 | 0 | ″ |
| | 5 | 5.65 | 0 | ″ |
| 9 month | 1 | 5.66 | 0 | Normal odor, oily separation in pockets throughout; edible |
| | 2 | 5.60 | 0 | ″ |
| | 3 | 5.59 | 0 | ″ |
| | 4 | 5.68 | 0 | Slightly putrid odor, gas production, oily |
| | | | | separation in pockets; edible |
| | 5 | 5.61 | 0 | Normal odor and appearance; edible |
| 12 month | 1 | 5.65 | 0 | Oily separation throughout, darkening; edible |
| | 2 | 5.61 | 0 | ″ |
| | 3 | 5.57 | 0 | Normal odor, darkening; edible |
| | 4 | 5.57 | 0 | ″ |
| | 5 | 5.57 | 0 | Oily separation throughout, darkening; edible |
| 18 month | 1 | 5.56 | 0 | Oily separation throughout, darkening, normal odor, edible |
| | 2 | 5.51 | 0 | ″ |
| | 3 | 5..51 | 0 | ″ |
| | 4 | 5.51 | 0 | ″ |
| | 5 | 5.59 | 0 | Slight oily separation throughout, darkening, |
| | | | | normal odor, edible |
| 24 month | 1 | 5.44 | 0 | Oily separation throughout, darkening, normal odor, edible |
| | 2 | 5.37 | 0 | ″ |
| | 3 | 5.44 | 0 | ″ |
| | 4 | 5.43 | 0 | ″ |
| | 5 | 5.51 | 0 | ″ |

^{a}pH determined with Orion 8104 combination pH electrode and Accumet pH meter
^{b}Mouse toxicity test, FDA Bacteriological Analytical Manual, 1995
^{c}Considered edible based on odor and appearance
^{d}0 = no toxicity detected, + = botulinal toxin confirmed

An economic spoilage study is typically not required by the FDA, but is more of a business, or economic vitality test. In one embodiment of the invention, an economic spoilage study was carried out using inoculated and control samples of the Formulas 1-3 listed above. The inoculated samples were inoculated with bacterial spores, such as, for example, aerobic spores including 4 species of Bacillus, and anaerobic spores including Clostridium sporogenes, followed by incubation at 86 degrees Fahrenheit (30 degrees Celsius). Again, assays were taken at intermittent periods in an 18 month testing period. A failing grade in the economic spoilage studies is defined as when a product has spoiled according to the consumer as a result of significant microbial growth. A consumer would not likely use the spoiled product, regardless of whether the product is safe to consume. No bacterial growth was observed in the inoculated and non-inoculated samples containing nisin or cultured dextrose, and in the non-inoculated sample without either nisin or cultured dextrose. Furthermore, these samples exhibited acceptable results with regards to the issues of thickening, browning, loss of cheese flavor, and emulsion stability over the shelf life of the cheese sauce. Bacterial growth was observed in the inoculated sample without either nisin or cultured dextrose, indicating that the addition of nisin or cultured dextrose is significant to inhibit microbial growth or spoilage.

In use, the cheese sauces of the present invention can be used as individual sauce pouches, or as part of a meal kit, such as a taco bake or a casserole product. The cheese sauces can be packaged in pouches, or any of a variety of suitable packaging means. The cheese sauces exhibit shelf life stability for a shelf life of about 12 months or greater, while exhibiting acceptable cheese sauce attributes, such as, for example, visual appearance, savory taste, flowability, emulsion stability, viscosity, and other such desirable attributes.

The invention may be embodied in other specific forms without departing from the essential attributes thereof; therefore, the illustrated embodiments should be considered in all respects as illustrative and not restrictive.

What is claimed is:

1. A shelf-stable cheese sauce comprising:
cheese solids present in an amount from about 10 weight percent or less;
at least one non-cheese dairy solid present in an amount from about 1 weight percent to about 25 weight percent;
water present in an amount from about 20 weight percent to about 60 weight percent;
nisin present in an amount from about 500 parts per million or less;
at least one phosphate salt present in an amount of about 1 part per million to about 1000 parts per million;
sodium chloride present in an amount of about 0.1 weight percent to about 3 weight percent; and
oil present in an amount of about 10 weight percent to about 20 weight percent,
wherein a pH level of the cheese sauce is in a range from about 5.45 to about 5.65, and a moisture content of the cheese sauce is in a range from about 45.0 percent to about 54.0 percent.

2. The cheese sauce according to claim 1, further comprising:
a filler present in an amount of about 0.1 weight percent to about 15 weight percent, wherein the filler is selected from the group consisting of corn syrup solids, maltodextrins, starches, flour, and combinations thereof.

3. The cheese sauce according to claim 1, further comprising:
at least one gum present in an amount of about 0.1 to about 5 weight percent, wherein the at least one gum is selected from the group consisting of sodium alginate, guar gum, xanthan gum, and combinations thereof.

4. The cheese sauce according to claim 1, further comprising:
an emulsifier present in an amount of about 0.1 weight percent to about 5 weight percent.

5. The cheese sauce according to claim 1, wherein the at least one non-cheese dairy solid is selected from the group consisting of butter milk, whey, sweet whey, non-fat dry milk, skim milk condensed, part skim milk condensed, whole milk condensed, rennet casein, milk protein concentrate, ultra-filtered milk, caseinate, milk protein isolates, whey protein concentrates, milk permeate, and combinations thereof.

6. The cheese sauce according to claim 1, wherein the at least one phosphate salt is selected from the group consisting of sodium mono-phosphate, sodium di-phosphate, and combinations thereof.

7. The cheese sauce according to claim 1, wherein the oil is selected from the group consisting of soybean oil, canola oil, vegetable oil, olive, oil, palm oil, peanut oil, lard, tallow, and combinations thereof.

8. The cheese sauce according to claim 1, further comprising:
a flavor system present in an amount of about 0.1 weight percent to about 10 weight percent.

9. The cheese sauce according to claim 8, wherein the flavor system is selected from the group consisting of garlic powder, onion powder, tomato powder, cumin powder, chili powder, monosodium glutamate (MSG), jalapeno puree, onion puree, garlic puree, parsley, parsley puree, any of a variety of peppers, black pepper, sugar, artificial flavors, and combinations thereof.

10. The cheese sauce according to claim 1, wherein the cheese solids is present in an amount of about 5 weight percent or less.

11. The cheese sauce according to claim 1, wherein the cheese sauce is processed using a pasteurization and hot fill process.

12. The cheese sauce according to claim 1, wherein the cheese sauce is packaged in a pouch.

13. A food kit having at least one cheese sauce pouch, the food kit comprising:
at least one pre-packaged food product;
at least one pouch containing a cheese sauce, wherein the cheese sauce comprises:
cheese solids present in an amount from about 10 weight percent or less,
at least one non-cheese dairy solid present in an amount from about 1 weight percent to about 25 weight percent,
water present in an amount from about 20 weight percent to about 60 weight percent,
nisin present in an amount from about 500 parts per million or less,
at least one phosphate salt present in an amount of about 1 parts per million to about 1000 parts per million,
sodium chloride present in an amount of about 0.1 weight percent to about 3 weight percent, and
oil present in an amount of about 10 weight percent to about 20 weight percent,
wherein a pH level of the cheese sauce is in a range from about 5.45 to about 5.65, and a moisture content of the cheese sauce is in a range from about 45.0 percent to about 54.0 percent; and
instructions to combine the at least one pre-packaged food product with the cheese sauce.

14. The food kit according to claim 13, wherein the at least one pre-packaged food product comprises dried pasta, refrigerated pasta, snack chips, rice, taco bake, potatoes, dehydrated vegetables, refrigerated vegetables, dough products, pizza-making components, and combinations thereof.

15. The food kit according to claim 13, wherein the at least one non-cheese dairy solid is selected from the group consisting of butter milk, whey, sweet whey, non-fat dry milk, skim milk condensed, part skim milk condensed, whole milk condensed, rennet casein, milk protein concentrate, ultra-filtered milk, caseinate, milk protein isolates, whey protein concentrates, milk permeate, and combinations thereof. [PLEASE PROVIDE OTHER EXAMPLES OF SUITABLE DAIRY SOLIDS, IF AVAILABLE]

16. The food kit according to claim 13, wherein the cheese solids of the cheese sauce is present in an amount of about 5 weight percent or less.

17. The food kit according to claim 13, wherein the cheese sauce is processed and packaged using a pasteurization and hot fill process.

18. The food kit according to claim 13, wherein the cheese sauce further comprises:
a flavor system present in an amount of about 0.1 weight percent to about 10 weight percent, wherein the flavor system is selected from the group consisting of garlic powder, onion powder, tomato powder, cumin powder, chili powder, monosodium glutamate (MSG), jalapeno puree, onion puree, garlic puree, parsley, parsley puree, any of a variety of peppers, black pepper, sugar, artificial flavors, and combinations thereof.
